(19) United States
(12) Patent Application Publication
(10) Pub. No.: US 2021/0206593 A1
(43) Pub. Date: Jul. 8, 2021

(54) AN INSTALLATION FOR SORTING MAILPIECES

(71) Applicant: SOLYSTIC, Bagneux (FR)

(72) Inventors: Damien Hugues, Upie (FR); Frederic Mestrallet, Etoile Sur Rhone (FR); Jeremy Duboscq, Bourg-Les-Valence (FR); Cedric Milord, Marches (FR)

(21) Appl. No.: 16/070,812

(22) PCT Filed: Jun. 15, 2018
(86) PCT No.: PCT/FR2018/051423

§ 371 Date: Jul. 18, 2018

(30) Foreign Application Priority Data
Aug. 4, 2017 (FR) 1757544

(51) Int. Cl. B65H 31/06; B07C 3/08

(52) U.S. Cl. CPC B65H 31/06; B65H 2701/1916; B07C 3/08

(57) ABSTRACT

An installation (1) for sorting mailpieces (2) includes an unstacker having an unstacking plate (3) suitable for separating a mailpiece at the head of a stack of mailpieces so as to feed a sorting conveyor (4) in which the mailpieces (1), as put into series, are moved in series and on edge. The installation (1) also includes: a feed inlet magazine (6) upstream from the unstacking plate with a motor-driven floor (8) designed to receive a stack of mailpieces (2) on edge; and a retaining paddle (9) that is mounted to move along the magazine and that is suitable for being placed behind the stack to keep it on edge while it is moving on the motor-driven floor towards the unstacking plate.

### TECHNICAL FIELD

The present invention relates to an installation for sorting mailpieces, which installation includes: an unstacker having an unstacking plate suitable for separating a mailpiece at the head of a stack of mailpieces so as to feed a sorting conveyor in which the mailpieces, as put into series, are moved in series and on edge; a feed inlet magazine upstream from said unstacking plate and having a motor-driven floor designed to receive a stack of mailpieces on edge; and a retaining paddle that is mounted to move along said magazine and that is suitable for being placed behind the stack to keep it on edge while it is moving on the motor-driven floor towards the unstacking plate.

### PRIOR ART

In this type of installation, mailpieces are unloaded regularly from a storage tray so as to be placed in a stack and on edge in the feed inlet magazine of the unstacker.

In the trays, the mailpieces are generally also stored in a stack and on edge, the stack extending in the length direction of the tray.

The trays can be unloaded manually, such manual unloading consisting in a machine operative taking a big handful of mailpieces and in placing it on a fixed (stationary) segment of the floor of the feed magazine that is situated upstream from another segment of the floor of the magazine that is motor driven (and therefore that is a moving segment) and that operates synchronously with the retaining paddle, as is well known, for example, from Patent Document FR 2 903 393.

In general, the stack of mailpieces tends to collapse once it is placed on the floor of the feed magazine, and so the machine operative uses one hand to retain the front of the stack relative to the unstacking plate, and the other hand to press the bases of the mailpieces at the back of the stack towards the first hand so as to straighten up the stack on edge. Whereupon, the machine operative slides the straightened-up stack on edge towards the unstacking plate, and positions the retaining paddle at the back of said stack so as to start the process of putting said stack into series.

Documents EP-A-0 562 954, EP-A-2 292 539 and DE-A-103 50 623 disclose semi-automated devices for facilitating conveying the articles on edge towards the unstacker.

However, straightening up and carrying the stack of mailpieces on edge are manual operations that require a physical effort that can give rise to occupational diseases.

An object of the invention is to remedy those drawbacks.

### SUMMARY OF THE INVENTION

To this end, the invention provides an installation for sorting mailpieces, which installation includes: an unstacker having an unstacking plate suitable for separating a mailpiece at the head of a stack of mailpieces so as to feed a sorting conveyor in which the mailpieces, as put into series, are moved in series and on edge; a feed inlet magazine upstream from the unstacking plate and having a motor-driven floor designed to receive a stack of mailpieces on edge; and a retaining paddle that is mounted to move along the magazine and that is suitable for being placed behind the stack to keep it on edge while it is moving on the motor-driven floor towards the unstacking plate; said installation being characterized in that the motor-driven floor of the magazine is made up of a plurality of motor-driven floor segments driven by respective independent motor-drives that are controlled selectively by a monitoring and control unit, in that a position sensor is provided for producing a signal indicating the relative position of the paddle relative to the motor-driven floor segments, and in that the monitoring and control unit is arranged to cause the segment(s) upstream from the paddle to advance at a speed/at speeds different from the speed(s) at which the segment(s) downstream from the paddle advance in such a manner as to force the mailpieces placed in a stack behind the paddle to straighten up on edge in reaction to the bases of the mailpieces being pressed against the paddle.

With these characteristics, the machine operative can effortlessly straighten up a stack of mailpieces that has slipped down or slumped behind the paddle, merely by supporting the front of the stack with one hand.

Due to the difference between the speeds of advance of the retaining paddle and of the motor-driven floor segments upstream therefrom, the retaining paddle going slower than segments upstream from it, the bases of the mailpieces are forced to straighten up against the retaining paddle, thereby tending to straighten up the mailpieces onto their edges.

The optimization of the process for feeding the unstacker with mailpieces makes it possible to improve the rate of sequencing of the mailpieces in the conveyor, and, more generally, makes it possible to increase the throughput rate at which the mailpieces are processed in the sorting installation.

This installation may have the following features:
the monitoring and control unit is arranged to reduce the speed(s) of advance of the motor-driven floor segments that are upstream from the paddle after a predetermined reference time; and
the paddle has a back that is provided with a retractable ramp. The ramp makes it possible to assist the operative in straightening up the stack by making the straightening-up more ergonomic.

### BRIEF DESCRIPTION OF THE DRAWINGS

In the drawings:

FIG. 1 is a highly diagrammatic view of a sorting installation of the invention; and

FIGS. 2a, 2b, 2c, and 2d are highly diagrammatic views of a portion of the sorting installation of the invention while a stack of mailpieces is being straightened up.

The invention is described in more detail below with reference to the drawings, which show an example of an installation for sorting mailpieces that includes a function of straightening up the stack of mailpieces in the feed inlet magazine.

### DESCRIPTION OF EMBODIMENTS

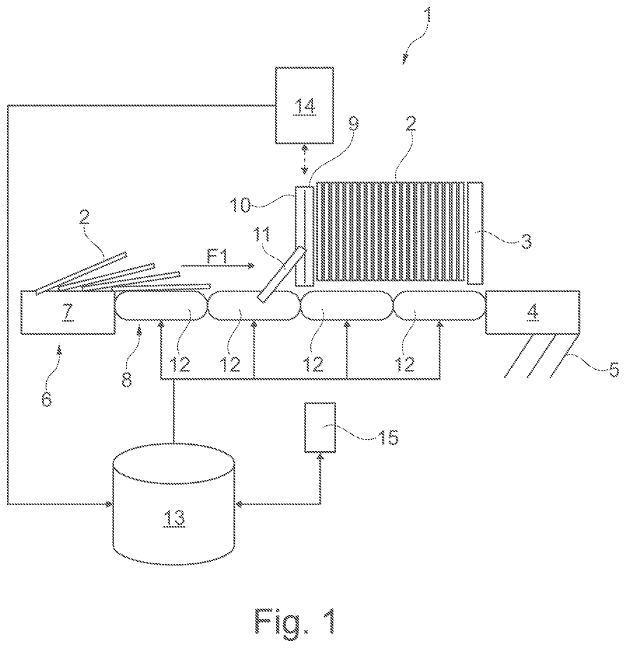

FIG. 1 shows a sorting installation 1 of the invention for sorting mailpieces 2, which installation includes an unstacker having an unstacking plate 3 designed to put a mailpiece at the head of a stack of mailpieces into series, and a sorting conveyor 4 fed by an unstacker and in which the mailpieces 2, as put into series, are moved on edge to sorting outlets 5.

The sorting installation 1 also includes a feed inlet magazine 6 for feeding in mailpieces 2 upstream from the unstacking plate 3, which magazine has a non-motor-driven floor 7 designed to receive a tray loaded with mailpieces 2 stored on edge that is placed on it by a machine operative.

Extending in alignment with and downstream from the non-motor-driven floor 7, the magazine 6 also includes a motor-driven floor 8 designed to receive the stack of mailpieces 2 on edge unloaded from the tray by the machine operative and that enables the stack of mailpieces 2 to be moved automatically towards the unstacking plate 3 in the conveying direction F1.

When processing mailpieces that are stored flat in the trays, a tilter is provided to tilt the tray automatically so that the mailpieces are placed on edge directly on the motor-driven floor.

A moving retaining paddle 9 is also provided that is mounted to move along the motor-driven floor 8 and along the non-motor-driven floor 7, which paddle is designed to be placed behind the stack of mailpieces 2 by the machine operative to keep it on edge while it is moving on the motor-driven floor 8 towards the unstacking plate 3.

It can be understood, in this example, that the rate at which the retaining paddle 9 advances against the stack of mailpieces 2 is a function of the rate at which the mailpieces 2 are unstacked.

The retaining paddle 9 also has a back 10 that is provided with a retractable ramp 11, which, in this example, is mounted to slide freely in the thickness of the paddle, so as to guide the straightening-up movement of another stack of mailpieces 2 that comes to be pressed against the retaining paddle 9.

More particularly, said ramp 11 has a horizontal top side that is mounted to slide in two vertical grooves in the paddle 9. A resilient member may be provided to force said ramp to take up, at rest, a retracted position in which it is retracted into the paddle, and a locking member may be provided to keep the ramp in the inclined position out of the paddle in such a manner as to straighten up a stack.

The motor-driven floor 8 of the magazine 6 is also made up of a plurality of motor-driven segments 12, each having an independent motor-drive that is controlled selectively by a monitoring and control unit 13.

In this example, each motor-driven segment is designed to move all of the mailpieces in a stack that fills one tray.

In this example, the monitoring and control unit 13 is designed to increase the speed(s) of the segment(s) 12 of motor-driven floor 8 that are upstream from the retaining paddle 9 relative to the speed(s) of the segment(s) that are downstream from the paddle relative to the conveying direction F1.

It can be understood that, in this example, the speeds of the motor-driven segments are synchronized between downstream and upstream from the paddle in order to guarantee optimum feeding of mailpieces at the unstacker.

In this example, the monitoring and control unit 13 is parameterized for two operating modes adapted to process respectively mailpieces that are stored on edge or mailpieces that are stored flat in the trays.

The operative can thus choose the appropriate operating mode as a function of the mailpieces loaded into the feed magazine.

In this example, a control panel 15 is thus provided in the vicinity of the motor-driven floor 8 for the purpose of selecting one of the two operating modes.

The sorting installation 1 also includes a position sensor 14 designed to send a signal to the monitoring and control unit 13 for the purpose of indicating the relative position of the paddle relative to the motor-driven floor segments.

The sorting installation also includes other sensors that are capable of producing data about the position of the stack on the feed magazine, the monitoring and control unit 13 being suitable for retrieving and processing said data so as to respond to it by controlling the speed of each segment independently from the other segments.

As a function of the data produced by the sensors, the monitoring and control unit 13 may also, for example, activate each segment 12 at an equivalent speed, gradually increase or reduce the speeds of the segments up to the retaining paddle 9 and even control the speeds of the segments 12 for a predetermined reference time.

When processing the mailpieces in the sorting installation of the invention, the machine operative starts by selecting the operating mode (on edge or flat) on the control panel 15.

So long as the operative does not change operating mode, the monitoring and control unit 13 continues to operate in the previously selected operating mode.

For sorting mailpieces 2 that are stored on edge in the trays, the machine operative starts by placing a tray loaded with mailpieces 2 on the non-motor-driven floor 7 and then retrieves the mailpieces 2 in handfuls so as to place them in a stack on the motor-driven floor 8 that operates continuously.

For sorting mailpieces 2 stored flat in the trays, the tilter automatically tilts the tray to place the mailpieces directly on the motor-driven floor 8. In this situation, the monitoring and control unit controls the segments as a function of the position of the stack that is detected by the sensors.

In both situations, the stack that has just been placed on edge tends to slip down or slump onto the motor-driven floor.

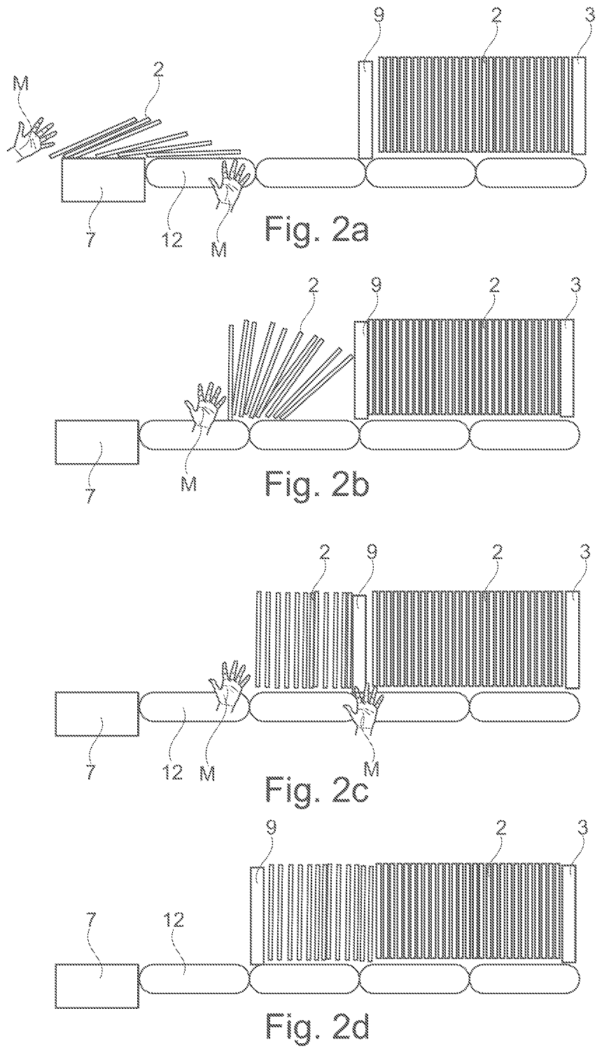

While the monitoring and control unit 13 is controlling the segments 12 in the chosen operating mode, the machine operative (represented by a hand M in FIG. 2a in this example) places the right hand at the front and under the stack and the left hand at the base and at the back of the stack and takes advantage of the stack moving on the segments 12 to start effortlessly straightening up the stack on edge against the retaining paddle 9.

Once the mailpiece at the head of the stack touches the retaining paddle 9, as can be seen in FIG. 2b, the operative withdraws the right hand while keeping the left hand at the base of the back of the stack to prevent the stack from tipping backwards, and takes advantage of the segments 12 moving automatically to bring the stack to end up straightening up on its own against the retaining paddle 9, as shown in FIG. 2c.

It can also be understood that when the paddle is provided with a ramp 11, the machine operative no longer needs to use the right hand to straighten up the stack of mailpieces 2 against the retaining paddle 9 because the mailpiece at the head of the stack then straightens up by itself along the back of the paddle.

The machine operative then moves the retaining paddle 9 so as to place it behind the stack of mailpieces 2 that has just been straightened up, as shown in FIG. 2d.

The position sensor 14 then detects a new position of the retaining paddle 9 and sends a signal to the monitoring and control unit 13, which reduces the speed of the segment 11 on which the newly straightened-up stack of mailpieces 2 between the retaining paddle 9 and the unstacking plate 3 is situated so that the speed is substantially the same as the speed of advance of the retaining paddle.

Once the reference time has elapsed, the segments upstream from the retaining paddle 9 are stopped, pending a new stack of mailpieces 2 to be straightened up.

1. An installation for sorting mailpieces comprising:
an unstacker having an unstacking plate suitable for separating a mailpiece at the head of a stack of mailpieces so as to feed a sorting conveyor in which the mailpieces, as put into series, are moved in series and on edge;
a feed inlet magazine upstream from said unstacking plate and having a motor-driven floor designed to receive a stack of mailpieces on edge; and
a retaining paddle that is mounted to move along said magazine and that is suitable for being placed behind the stack to keep it on edge while it is moving on said motor-driven floor towards the unstacking plate;
wherein said motor-driven floor of said magazine is made up of a plurality of motor-driven floor segments driven by respective independent motor-drives that are controlled selectively by a monitoring and control unit, said installation further comprising a position sensor provided for producing a signal indicating the relative position of said retaining paddle relative to said motor-driven floor segments, and wherein said monitoring and control unit is arranged to cause the segment(s) upstream from the paddle to advance at a speed/at speeds different from the speed(s) at which the segment(s) downstream from said paddle advance in such a manner as to force the mailpieces placed in a stack behind the paddle to straighten up on edge in reaction to the bases of the mailpieces being pressed against said retaining paddle.

2. The installation according to claim 1, wherein said monitoring and control unit is arranged to reduce the speed(s) of advance of the motor-driven floor segments that are upstream from the retaining paddle after a predetermined reference time.

3. The installation according to claim 2, wherein said retaining paddle has a back that is provided with a retractable ramp.

4. The installation according to claim 1, wherein said retaining paddle has a back that is provided with a retractable ramp.
